(19) United States
(12) Patent Application Publication
(10) Pub. No.: US 2022/0238862 A1
(43) Pub. Date: Jul. 28, 2022

(54) Non-Aqueous Electrolyte Secondary Battery

(71) Applicant: Prime Planet Energy & Solutions, Inc., Tokyo (JP)

(72) Inventors: Takatoshi HIGUCHI, Kakogawa-shi (JP); Hidekazu HIRATSUKA, Osaka (JP)

(21) Appl. No.: 17/580,646

(22) Filed: Jan. 21, 2022

(30) Foreign Application Priority Data
Jan. 25, 2021 (JP) 2021-009490

(51) Int. Cl. H01M 4/36

(52) U.S. Cl. CPC H01M 4/364; H01M 2004/021

(57) ABSTRACT

A non-aqueous electrolyte secondary battery includes a positive electrode, a negative electrode, and an electrolyte solution. In number-based particle size distribution, the positive electrode active material has a first peak and a second peak. The first peak has a first vertex. The second peak has a second vertex. The first vertex is located on a smaller particle size side from the second vertex. The first peak is attributed to first particles. The second peak is attributed to second particles. The first particles include aggregated primary particles and films. Each film is adhered to a surface of each primary particle. The film includes a metallic element. Relationships of expression (I) “R=C/D” and expression (II) “1.54≤R≤1.75” are satisfied. In the expression (I), C [ppm] represents a mass fraction of the metallic element relative to the first particles, and D [Å] represents a crystallite size of the first particles.

This nonprovisional application is based on Japanese Patent Application No. 2021-009490 filed on Jan. 25, 2021, with the Japan Patent Office, the entire contents of which are hereby incorporated by reference.

### BACKGROUND OF THE INVENTION

### Field of the Invention

The present technique relates to a non-aqueous electrolyte secondary battery.

### Description of the Background Art

Japanese Patent Laying-Open No. 2011-113825 discloses a positive electrode material where the average secondary particle size of a first positive electrode active material is larger than the average secondary particle size of a second positive electrode active material.

### SUMMARY OF THE INVENTION

There is a demand for enhanced output properties of a non-aqueous electrolyte secondary battery (which may be simply called “battery” hereinafter). For enhancing output properties, forming a positive electrode active material as a mixture of large particles and small particles is considered, for example. With the small particles thus mixed, the reaction area of the positive electrode active material is increased. With the reaction area thus increased, lithium (Li) ion insertion reaction may be facilitated. That is, output properties are expected to be enhanced. However, degradation reaction of electrolyte solution during high-temperature storage may also be facilitated, for example. That is, endurance may be decreased.

For inhibiting degradation reaction of electrolyte solution, forming a film on the surface of the small particle is considered. However, the film may also inhibit the Li-ion insertion reaction. That is, the film formation may degrade output properties. Therefore, conventionally, it has been difficult to obtain both output properties and endurance.

An object of the technique according to the present application (herein also called “the present technique”) is to obtain both output properties and endurance.

Hereinafter, the configuration and effects of the present technique will be described. It should be noted that the action mechanism according to the present technique includes presumption. The scope of the present technique should not be limited by whether or not the action mechanism is correct.

[1] A non-aqueous electrolyte secondary battery includes a positive electrode, a negative electrode, and an electrolyte solution.

The positive electrode includes a positive electrode active material. In number-based particle size distribution, the positive electrode active material has a first peak and a second peak. The first peak has a first vertex. The second peak has a second vertex. The first vertex is located on a smaller particle size side from the second vertex.

The first peak is attributed to first particles. The second peak is attributed to second particles.

The first particles include aggregated primary particles and films. Each film is adhered to a surface of each primary particle. The film includes a metallic element.

Relationships of the following expression (I) and expression (II) are satisfied:

R=C/D (I)

1.54≤R≤1.75 (II).

In the above expression (I), “C [ppm]” represents a mass fraction of the metallic element relative to the first particles, and “D [Å]” represents a crystallite size of the first particles.

The positive electrode active material according to the present technique includes first particles (small particles) and second particles (large particles). The first particles are aggregated primary particles (secondary particles). On a surface of each first particle, a film is formed.

According to new findings from the present technique, when the value R is from 1.54 to 1.75, both output properties and endurance are expected to be obtained. The value R is calculated by the above expression (I). The value R is the ratio of the value C to the value D. The value D represents the crystallite size. It seems that the value D reflects the size of the primary particles. The value C represents the mass fraction of the metallic element included in the film, relative to the first particles. The value C may be regarded as the amount of adhered film. Therefore, the value R may be regarded as the ratio of the amount of adhered film to the size of the primary particles.

It seems that the size of the primary particles reflects the reaction area. It seems that the smaller the size of the primary particles is, the larger the reaction area is. On the other hand, it seems that the higher the amount of adhered film is, the smaller the reaction area is. Therefore, it seems that when a film is formed in an amount appropriate to the size of the primary particles, both output properties and endurance are obtained.

When the value R is lower than 1.54, a desired level of endurance may not be obtained. It may be because the size of the primary particles and the amount of adhered film are out of balance. When the value R is higher than 1.75, desired output properties may not be obtained. It may be because the size of the primary particles and the amount of adhered film are out of balance.

[2] The metallic element may include, for example, at least one selected from the group consisting of aluminum (Al), boron (B), titanium (Ti), and yttrium (Y).

The metallic element according to the present technique also includes a metalloid element (such as B). The film according to the present technique may include two or more metallic elements.

[3] The crystallite size may be from 602 Å to 678 Å, for example. The mass fraction of the metallic element relative to the first particles may be from 930 ppm to 1072 ppm, for example.

[4] In the particle size distribution, the first vertex may be located within the range of 2 μm to 6 μm, for example, and the second vertex may be located within the range of 15 μm to 20 μm, for example.

[5] The first particles may include a first lithium-nickel composite oxide, for example. The second particles may include a second lithium-nickel composite oxide, for example. The first lithium-nickel composite oxide includes nickel in a first molar fraction. The second lithium-nickel composite oxide includes nickel in a second molar fraction. The first molar fraction may be higher than the second molar fraction, for example.

The foregoing and other objects, features, aspects and advantages of the present technique will become more apparent from the following detailed description of the present technique when taken in conjunction with the accompanying drawings.

### BRIEF DESCRIPTION OF THE DRAWINGS

FIG. 1 is a schematic view illustrating an example configuration of a non-aqueous electrolyte secondary battery according to the present embodiment.

FIG. 2 is a schematic view illustrating an example configuration of an electrode assembly according to the present embodiment.

FIG. 3 is an example of particle size distribution of a positive electrode active material according to the present embodiment.

### DESCRIPTION OF THE PREFERRED EMBODIMENTS

In the following, an embodiment of the present technique (also called “the present embodiment” herein) will be described. It should be noted that the below description does not limit the scope of the present technique.

Expressions such as “comprise, include” and “have”, and other similar expressions (such as “be composed of”, “encompass, involve”, “contain”, “carry, support”, and “hold”, for example) herein are open-ended expressions. In other words, each of these expressions means that a certain configuration is included but this configuration is not necessarily the only configuration that is included. The expression “consist of” is a closed-end expression. The expression “consist essentially of” is a semiclosed-end expression. In other words, the expression “consist essentially of” means that an additional component may also be included in addition to an essential component or components, unless an object of the present technique is impaired. For example, a component that is usually expected to be included in the relevant field to which the present technique pertains (such as inevitable impurities, for example) may also be included as an additional component.

A singular form (“a”, “an”, and “the”) herein also includes its plural meaning, unless otherwise specified. For example, “a particle” may include not only “a single particle” but also “a group of particles (powder, particles, and the like)”.

In the present specification, when a compound is represented by a stoichiometric composition formula such as “LiCoO₂”, this stoichiometric composition formula is merely a typical example. The composition ratio may be non-stoichiometric. For example, when lithium cobalt oxide is represented as “LiCoO₂”, the composition ratio of lithium cobalt oxide is not limited to “Li/Co/O=1/1/2” but Li, Co, and O may be included in any composition ratio, unless otherwise specified.

A numerical range such as “from 602 Å to 678 Å” herein includes both the upper limit and the lower limit, unless otherwise specified. For example, “from 602 Å to 678 Å” means a numerical range of “not less than 602 Å and not more than 678 Å”. Moreover, any numerical value selected from a certain numerical range may be used as a new upper limit and/or a new lower limit. For example, any numerical value from a certain numerical range and any numerical value described in another location of the present specification may be combined to create a new numerical range.

Any geometric term herein (such as “perpendicular”, for example) should not be interpreted solely in its exact meaning. For example, “perpendicular” may mean a geometric state that is deviated, to some extent, from exact “perpendicular”. Any geometric term herein may include tolerances and/or errors in terms of design, operation, production, and/or the like. Moreover, the dimensional relationship in each figure may not necessarily coincide with the actual dimensional relationship. The dimensional relationship (in length, width, thickness, and the like) in each figure may have been changed for the purpose of assisting the understanding of the present technique. Further, a part of a configuration may have been omitted.

<Non-Aqueous Electrolyte Secondary Battery>

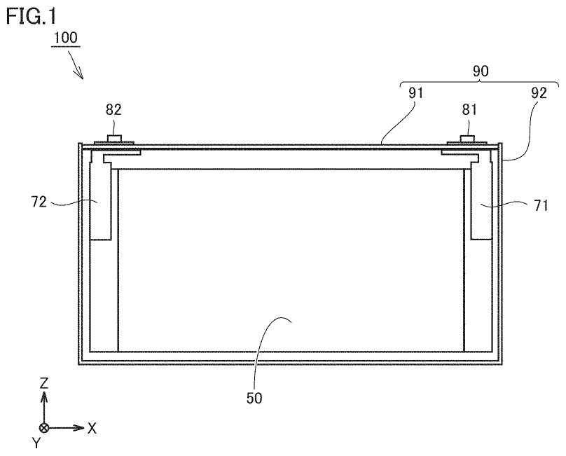

FIG. 1 is a schematic view illustrating an example configuration of a non-aqueous electrolyte secondary battery according to the present embodiment.

A battery 100 may be used for any purpose of use. For example, battery 100 may be used as a main electric power supply or a motive force assisting electric power supply in an electric vehicle. A plurality of batteries 100 may be connected together to form a battery module or a battery pack. Battery 100 has a predetermined rated capacity. Battery 100 may have a rated capacity from 1 Ah to 200 Ah, for example.

Battery 100 includes a housing 90. Housing 90 is prismatic (a flat, rectangular parallelepiped). However, prismatic is merely an example. Housing 90 may have any configuration. Housing 90 may be cylindrical or may be a pouch, for example. Housing 90 may be made of Al alloy, for example. Housing 90 accommodates an electrode assembly 50 and an electrolyte solution (not illustrated). Housing 90 may include a sealing plate 91 and an exterior can 92, for example. Sealing plate 91 closes an opening of exterior can 92. Sealing plate 91 and exterior can 92 may be bonded together by laser beam welding, for example.

Sealing plate 91 is provided with a positive electrode terminal 81 and a negative electrode terminal 82. Sealing plate 91 may further be provided with an inlet and a gas-discharge valve. Through the inlet, the electrolyte solution may be injected into housing 90. Electrode assembly 50 is connected to positive electrode terminal 81 via a positive electrode current-collecting member 71. Positive electrode current-collecting member 71 may be an Al plate and/or the like, for example. Electrode assembly 50 is connected to negative electrode terminal 82 via a negative electrode current-collecting member 72. Negative electrode current-collecting member 72 may be a copper (Cu) plate and/or the like, for example.

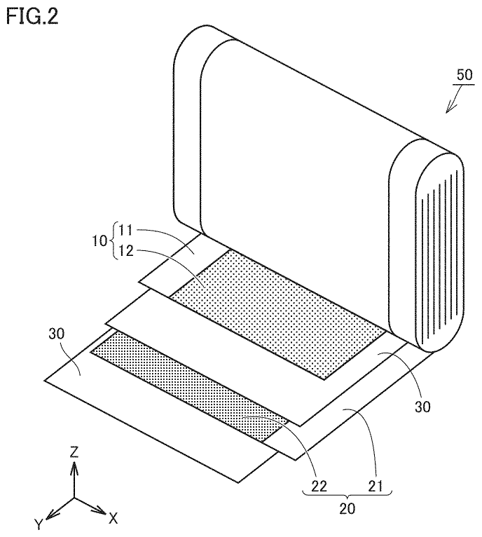

FIG. 2 is a schematic view illustrating an example configuration of an electrode assembly according to the present embodiment.

Electrode assembly 50 is a wound-type one. Electrode assembly 50 includes a positive electrode 10, a separator 30, and a negative electrode 20. In other words, battery 100 includes positive electrode 10, negative electrode 20, and an electrolyte solution. Each of positive electrode 10, separator 30, and negative electrode 20 is a belt-shaped sheet. Electrode assembly 50 may include a plurality of separators 30. Electrode assembly 50 is formed by stacking positive electrode 10, separator 30, and negative electrode 20 in this order and then winding them spirally. One of positive electrode 10 and negative electrode 20 may be interposed between separators 30. Both positive electrode 10 and negative electrode 20 may be interposed between separators 30. After the winding, electrode assembly 50 may be shaped into a flat form. The wound-type is merely an example. Electrode assembly 50 may be a stack-type one, for example.

<<Positive Electrode>>

Positive electrode 10 may include a positive electrode substrate 11 and a positive electrode active material layer 12, for example. Positive electrode substrate 11 is a conductive sheet. Positive electrode substrate 11 may be an Al alloy foil and/or the like, for example. The “thickness” of each member herein may be measured with a constant-pressure thickness-measuring instrument (a thickness gauge). Positive electrode substrate 11 may have a thickness from 10 μm to 30 μm, for example. Positive electrode active material layer 12 may be placed on the surface of positive electrode substrate 11. Positive electrode active material layer 12 may be placed on only one side of positive electrode substrate 11, for example. Positive electrode active material layer 12 may be placed on both sides of positive electrode substrate 11, for example. From one end in a width direction (in the X-axis direction in FIG. 2) of positive electrode 10, positive electrode substrate 11 may be exposed. To the exposed portion of positive electrode substrate 11, positive electrode current-collecting member 71 may be bonded.

Positive electrode active material layer 12 may have a thickness from 10 μm to 200 μm, for example. Positive electrode active material layer 12 includes a positive electrode active material. In other words, positive electrode 10 includes a positive electrode active material.

(Positive Electrode Active Material)

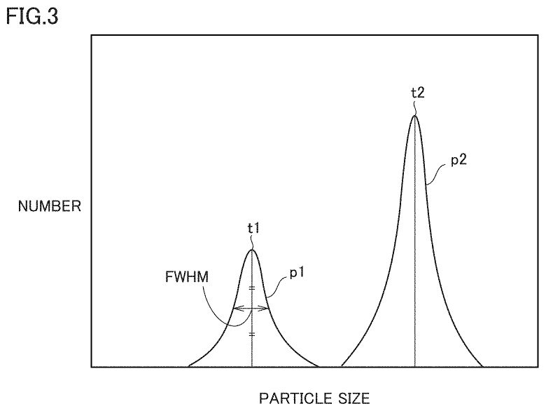

FIG. 3 is an example of particle size distribution of a positive electrode active material according to the present embodiment.

The particle size distribution in FIG. 3 is based on number. The particle size distribution is a multimodal-type one. More specifically, in the number-based particle size distribution, the positive electrode active material includes a first peak p1 and a second peak p2. First peak p1 has a first vertex t1. Second peak p2 has a second vertex t2. The “vertex” herein refers to a peak top. First vertex t1 is located on a smaller particle size side from second vertex t2.

First peak p1 is attributed to first particles. Second peak p2 is attributed to second particles. That is, the positive electrode active material includes first particles (small particles) and second particles (large particles). The positive electrode active material may consist essentially of the first particles and the second particles. The positive electrode active material may be prepared by, for example, mixing the first particles (powder) and the second particles (powder). The mixing ratio may be “(first particles)/(second particles)=10/90 to 50/50 (mass ratio)”, for example. The first particles (powder) may have a tap bulk density from 1.9 g/cm³ to 2.8 g/cm³, for example. The tap bulk density may be measured in accordance with “JIS R 1628:1997”.

First vertex t1 may be located within the range of 2 μm to 6 μm, for example. Second vertex t2 may be located within the range of 15 μm to 20 μm, for example. The particle size at second vertex t2 may be, for example, three to five times greater than the particle size at first vertex t1.

For example, the area of first peak p1 may be smaller than the area of second peak p2. That is, the first particles may be fewer than the second particles.

The particle size distribution of the positive electrode active material is acquired by image analysis. From positive electrode active material layer 12, a plurality of cross-sectional samples are prepared. Each cross-sectional sample may include, for example, a cross section perpendicular to a surface of positive electrode active material layer 12. The side to be observed is cleaned by a CP (cross-section polisher) and/or the like, for example. The cross-sectional sample is observed with an SEM (scanning electron microscope). The magnification for observation is adjusted in such a way that 10 to 100 particles are included within an image. The Feret diameters of all the particles in the image are measured. The plurality of cross-sectional samples are observed to obtain a total of 1000 or more Feret diameters. From the 1000 or more Feret diameters, number-based particle size distribution is created.

(Chemical Composition)

In the particle size distribution, first peak p1 and second peak p2 are identified. The cross sections of the particles included within the FWHM (full width at half maximum) of first peak p1 may be analyzed by EDX (energy dispersive X-ray spectroscopy), to identify the chemical composition of the first particles. The cross sections of the particles included within the FWHM of second peak p2 may be analyzed by EDX to identify the chemical composition of the second particles.

Each of the first particles and the second particles may independently have any chemical composition. The first particles may include a first lithium-nickel composite oxide, for example. The second particles may include a second lithium-nickel composite oxide, for example.

The first lithium-nickel composite oxide may be expressed by, for example, the following formula (III):

LiNiₐ₁Co_{b1}Mn_{c1}O₂ (III).

In the above formula (III), relationships of “0.4≤a1<1, 0<b1≤0.3, 0<c1≤0.3, a1+b1+c1=1” may be satisfied, for example, and relationships of “0.5≤a1≤0.8, 0.1≤b1≤0.25, a1+b1+c1=1” may be satisfied, for example.

The second lithium-nickel composite oxide may be expressed by, for example, the following formula (IV):

LiNiₐ₂Co_{b2}Mn_{c2}O₂ (IV).

In the above formula (IV), relationships of “0.4≤a2<1, 0<b2≤0.3, 0<c2≤0.3, a2+b2+c2=1” may be satisfied, for example, and relationships of “0.5≤a2≤0.8, 0.1≤b2≤0.25, 0.1≤c2≤0.25, a2+b2+c2=1” may be satisfied, for example.

In the above formula (III), “a1” represents the molar fraction of nickel (Ni) in the first lithium-nickel composite oxide (a first molar fraction). For example, when a1=0.6, 1 mol of the first lithium-nickel composite oxide includes 0.6 mol of Ni. In the above formula (IV), “a2” represents the molar fraction of nickel in the second lithium-nickel composite oxide (a second molar fraction). In the above formulae (III) and (IV), the relationship “a1>a2” may be satisfied, for example. That is, the first molar fraction may be higher than the second molar fraction. For example, relationships of “0.60≤a1≤0.85, 0.45≤a2≤0.55” may be satisfied.

(Particle Configuration)

Each of the first particles and the second particles independently include aggregated primary particles (secondary particles). The first particles further include films. In other words, the first particles include aggregated primary particles and films. Each film is adhered to a surface of each primary particle. The second particles may include films or may not include films.

(Crystallite Size)

The crystallite size of the first particles reflects the size of the primary particles.

The crystallite size is calculated by the following equation (V):

D=Kλ/(β cos θ) (V).

The above equation (V) is also called “the Scherrer equation”. In the above equation (V), “D” represents the crystallite size, and “K” represents the shape factor. In the present embodiment, K=0.9. “λ” represents the wavelength of X-ray. “β” represents the FWHM of the target diffraction peak. The unit of FWHM is radian. “θ” represents a Bragg angle of the target diffraction peak.

“β” and “θ” are determined from XRD (X-ray diffraction) profile. On a surface of a glass sample plate, the first particles (powder) are placed. During measurement, the sample is covered with a resin film and/or the like so as to avoid exposure of the sample to air. The XRD measurement conditions are as follows, for example.

Measurement temperature: 20° C.±5° C.

X-ray source: Cu-Kα ray (wavelength, λ=1.5418 Å)

Detector: LYNX EYE (manufactured by Bruker)

X-ray output: 40 kV×40 mA

Goniometer radius: 250 mm

Measurement mode: continuous

Counting unit: cps

Scanning speed: 0.03°/s

Measurement start angle: 10°

Measurement end angle: 120°

From the XRD profile, the FWHM (β) of the 104 diffraction peak and the Bragg angle (θ) of the 104 diffraction peak are determined. The values “λ”, “β”, and “θ” are substituted into the above equation (V) to determine the crystallite size.

The crystallite size of the first particles may be from 602 Å to 678 Å (from 60.2 nm to 67.8 nm), for example. The crystallite size of the first particles may be 613 Å or more, for example. The crystallite size of the first particles may be 627 Å or less, for example.

(Film)

Each film is adhered to a surface of each primary particle. The film includes a metallic element. The film may consist essentially of a metallic element. The metallic element may include, for example, at least one selected from the group consisting of Al, B, Ti, and Y. The film may further include a non-metallic element (such as oxygen, carbon, and/or fluorine, for example).

In the present embodiment, the amount of adhered film refers to the mass fraction of the metallic element included in the film, relative to the first particles. The amount of adhered film is measured by ICP-AES (inductively coupled plasma atomic emission spectroscopy). For example, an ICP-AES apparatus “iCAP6300” (trade name) manufactured by Thermo Fisher Scientific, and/or the like may be used. An ICP-AES apparatus with equivalent function may also be used. 0.2-M (0.2 mol/L) nitric acid is prepared. 0.2 g of the first particles are dissolved in the nitric acid to prepare a solution. The resulting solution is filtrated through a 0.2-μm filter to prepare a sample liquid (filtrate). The sample liquid is introduced into the ICP-AES apparatus to measure the mass fraction of the metallic element included in the film, relative to the first particles. When the film includes multiple types of metallic elements, the sum of the mass fractions of all the metallic elements is regarded as “the mass fraction of the metallic element”. For example, when the film includes Al and B, the sum of the Al mass fraction and the B mass fraction is measured.

The amount of adhered film may be from 930 ppm to 1072 ppm, for example. The amount of adhered film may be 1064 ppm or less, for example. The amount of adhered film may be 1064 ppm or more, for example.

(Value R)

As found in the above expression (I), the amount of adhered film is divided by the crystallite size to calculate a value R. The result of the division is significant to two decimal place. It is rounded to two decimal place. In the present embodiment, the value R is from 1.54 to 1.75. When the value R is from 1.54 to 1.75, both output properties and endurance are expected to be obtained. The value R may be 1.57 or more, for example. The value R may be 1.70 or more, for example.

(Other Components)

In addition to the positive electrode active material, positive electrode active material layer 12 may further include a conductive material, a binder, and the like, for example. Positive electrode active material layer 12 may include the positive electrode active material in an amount from 80% to 99% and the conductive material in an amount from 0.1% to 10% in terms of, for example, mass fraction, with the remainder being made up of the binder. The conductive material may include an optional component. The conductive material may include carbon black and/or the like, for example. The binder may also include an optional component. The binder may include polyvinylidene difluoride (PVdF) and/or the like, for example.

<<Negative Electrode>>

Negative electrode 20 may include a negative electrode substrate 21 and a negative electrode active material layer 22, for example. Negative electrode substrate 21 is a conductive sheet. Negative electrode substrate 21 may be a Cu alloy foil and/or the like, for example. Negative electrode substrate 21 may have a thickness from 5 μm to 30 μm, for example. Negative electrode active material layer 22 may be placed on the surface of negative electrode substrate 21. Negative electrode active material layer 22 may be placed on only one side of negative electrode substrate 21, for example. Negative electrode active material layer 22 may be placed on both sides of negative electrode substrate 21, for example. From one end in a width direction (in the X-axis direction in FIG. 2) of negative electrode 20, negative electrode substrate 21 may be exposed. To the exposed portion of negative electrode substrate 21, negative electrode current-collecting member 72 may be bonded.

Negative electrode active material layer 22 may have a thickness from 10 μm to 200 μm, for example. Negative electrode active material layer 22 includes a negative electrode active material. The negative electrode active material may include an optional component. The negative electrode active material may include, for example, at least one selected from the group consisting of graphite, soft carbon, hard carbon, silicon, silicon oxide, silicon-based alloy, tin, tin oxide, tin-based alloy, and lithium-titanium composite oxide.

In addition to the negative electrode active material, negative electrode active material layer 22 may further include a binder and/or the like, for example. Negative electrode active material layer 22 may include the negative electrode active material in an amount from 95% to 99.5% in terms of, for example, mass fraction, with the remainder being made up of the binder. The binder may include an optional component. The binder may include, for example, at least one selected from the group consisting of carboxymethylcellulose (CMC) and styrene-butadiene rubber (SBR).

<<Separator>>

At least part of separator 30 is interposed between positive electrode 10 and negative electrode 20. Separator 30 separates positive electrode 10 from negative electrode 20. Separator 30 may have a thickness from 10 μm to 30 μm, for example.

Separator 30 is a porous sheet. Separator 30 allows for permeation of the electrolyte solution therethrough. Separator 30 may have an air permeability from 100 s/100 mL to 400 s/100 mL, for example. The “air permeability” herein refers to the “Air Resistance” defined by “JIS P 8117:2009”. The air permeability is measured by a Gurley test method.

Separator 30 is electrically insulating. Separator 30 may include a polyolefin-based resin and/or the like, for example. Separator 30 may consist essentially of a polyolefin-based resin, for example. The polyolefin-based resin may include, for example, at least one selected from the group consisting of polyethylene (PE) and polypropylene (PP). Separator 30 may have a monolayer structure, for example. Separator 30 may consist essentially of a PE layer, for example. Separator 30 may have a multilayer structure, for example. Separator 30 may be formed, for example, by stacking a PP layer, a PE layer, and a PP layer in this order. On a surface of separator 30, a heat-resistant layer and/or the like may be formed, for example.

<<Electrolyte Solution>>

The electrolyte solution includes a solvent and a supporting electrolyte. The solvent is aprotic. The solvent may include an optional component. The solvent may include, for example, at least one selected from the group consisting of ethylene carbonate (EC), propylene carbonate (PC), butylene carbonate (BC), dimethyl carbonate (DMC), ethyl methyl carbonate (EMC), diethyl carbonate (DEC), 1,2-dimethoxyethane (DME), methyl formate (MF), methyl acetate (MA), methyl propionate (MP), and γ-butyrolactone (GBL).

The supporting electrolyte is dissolved in the solvent. The supporting electrolyte may include, for example, at least one selected from the group consisting of LiPF₆, LiBF₄, and LiN(FSO₂)₂. The supporting electrolyte may have a molarity from 0.5 mol/L to 2.0 mol/L, for example. The supporting electrolyte may have a molarity from 0.8 mol/L to 1.2 mol/L, for example.

In addition to the solvent and the supporting electrolyte, the electrolyte solution may further include an optional additive. For example, the electrolyte solution may include an additive in a mass fraction from 0.01% to 5%. The additive may include, for example, at least one selected from the group consisting of vinylene carbonate (VC), lithium difluorophosphate (LiPO₂F₂), lithium fluorosulfonate (FSO₃Li), and lithium bis(oxalato)borate (LiBOB).

### Examples

Next, examples according to the present technique (also called “the present example” herein) will be described. It should be noted that the below description does not limit the scope of the present technique.

<Production of Non-Aqueous Electrolyte Secondary Battery>

In the following manner, test cells according to No. 1 to No. 13 (non-aqueous electrolyte secondary batteries) were fabricated. In the present example, as a typical example, the process of fabrication of No. 6 is described.

<<No. 6>>

(Production of Positive Electrode)

As a first lithium-nickel composite oxide, LiNi_{0.60}Co_{0.20}Mn_{0.20}O₂ was prepared. The first lithium-nickel composite oxide had a median diameter of 3.96 μm in volume-based particle size distribution. The first lithium-nickel composite oxide, a predetermined amount of Al₂O₃, and a predetermined amount of HBO₃ were mixed to prepare a mixed powder. The mixed powder was calcined in an air atmosphere. Thus, first particles were prepared. The first particles included aggregated primary particles. The crystallite size of the first particles was 613 Å. The surface of each primary particle had a film formed thereon. The film included Al and B. The amount of adhered film was 1072 ppm.

As a second lithium-nickel composite oxide, LiNi_{0.55}Co_{0.20}Mn_{0.25}O₂ was prepared. The second lithium-nickel composite oxide had a median diameter of 16.7 μm in volume-based particle size distribution. The second lithium-nickel composite oxide was to be used as second particles, without further treatment.

The below materials were prepared.

Positive electrode active material: first particles, second particles (those obtained in the above manner)

Conductive material: carbon black

Binder: PVdF

Dispersion medium: N-methyl-2-pyrrolidone

Positive electrode substrate: Al foil

Tab terminal: thin Al plate

The first particles and the second particles were mixed together to prepare a positive electrode active material (a mixed powder). The mixing ratio was “(first particles)/(second particles)=50/50 (mass ratio)”. 97.6 parts by mass of the mixed powder, 1.5 parts by mass of the conductive material, 0.9 parts by mass of the binder, and a predetermined amount of the dispersion medium were mixed to prepare a positive electrode slurry. The positive electrode slurry was applied to the surface of the positive electrode substrate, followed by drying, and thereby, a positive electrode active material layer was formed. A rolling mill was used to compress the positive electrode active material layer. Thus, a positive electrode raw sheet was produced. The positive electrode raw sheet was cut into a predetermined size to produce a positive electrode. To the positive electrode, the tab terminal was bonded.

It is expected that the positive electrode active material that is included in the compressed positive electrode active material layer has a first peak and a second peak in number-based particle size distribution. It is because the volume-based median diameter of the first particles and the volume-based median diameter of the second particles differ by 12.74 μm. It is expected that the vertex of the first peak is located within the range of 2 μm to 6 μm. It is expected that the first peak is attributed to the first particles. It is expected that the vertex of the second peak is located within the range of 15 μm to 20 μm. It is expected that the second peak is attributed to second particles.

(Production of Negative Electrode)

The below materials were prepared.

Negative electrode active material: graphite

Binder: CMC, SBR

Dispersion medium: water

Negative electrode substrate: Cu foil

Tab terminal: thin Ni plate

98 parts by mass of the negative electrode active material, 1 part by mass of CMC, 1 part by mass of SBR, and a predetermined amount of the dispersion medium were mixed to prepare a negative electrode slurry. The negative electrode slurry was applied to the surface of the negative electrode substrate, followed by drying, and thereby a negative electrode active material layer was formed. A rolling mill was used to compress the negative electrode active material layer. Thus, a negative electrode raw sheet was produced. The negative electrode raw sheet was cut into a predetermined size to produce a negative electrode. To the negative electrode, the tab terminal was bonded.

(Assembly)

As a separator, a porous polyolefin sheet was prepared. The positive electrode, the separator, and the negative electrode were stacked in such a way that the separator was interposed between the positive electrode and the negative electrode. Thus, an electrode assembly was formed. As a housing, a pouch made of Al-laminated film was prepared. The electrode assembly was placed in the housing.

(Injection of Electrolyte Solution)

An electrolyte solution was prepared. The electrolyte solution included the below components. The electrolyte solution was injected into the housing. The housing was hermetically sealed. In this manner, a test cell was fabricated.

Solvent: EC/EMC=3/7 (volume ratio)

Supporting electrolyte: LiPF₆ (1 mol/L)

Additive: VC (mass fraction, 0.3%)

(Initial Charge and Discharge)

In an environment at a temperature of 25° C., initial charge and discharge was carried out. At a current of 0.2 mA/cm², until a positive electrode electric potential of 4.35 V (vs. Li⁺/Li) was reached, the test cell was charged in a constant-current mode. Then, until a current of 0.04 mA/cm² was reached, the test cell was charged in a constant-voltage mode. In this way, initial charged capacity was measured. After 10 minutes of resting, at a current of 0.2 mA/cm², until a positive electrode electric potential of 2.5 V (vs. Li⁺/Li) was reached, the test cell was discharged in a constant-current mode. In this way, initial discharged capacity was measured. The initial discharged capacity was divided by the mass of the positive electrode active material, and thus the specific capacity (capacity per unit mass) of the positive electrode active material was measured. In the present example, substantially the same level of specific capacity was observed for all the test cells. The value of current [mA/cm²] in the present example had been normalized by the area of the positive electrode.

<<No. 1 to No. 5, No. 7 to No. 13>>

Test cells were fabricated in the same manner as for No. 6 except that the crystallite size of the first particles and the amount of adhered film were changed as specified in Table 1 below. The crystallite size of the first particles and the amount of adhered film were adjusted by changing, for example, the calcination duration, the calcination temperature, the amount of the film material, and/or the like.

<Evaluation>

<<Output Properties>>

The SOC (state of charge) of the test cell was adjusted to 50%. The SOC in the present example refers to the percentage of the charged capacity at a point of time in question relative to the initial discharged capacity. After the SOC adjustment, the test cell was discharged. In this way, the internal resistance (DCIR) of the test cell was calculated. The internal resistance is found in Table 1 below. In Table 1 below, the values in column “Internal resistance” are relative values. In the present example, the internal resistance of No. 6 is defined as 100. The lower the internal resistance is, the better the output properties are expected to be.

<<Endurance>>

In a discharged state, the volume (the pre-storage volume) of the test cell was measured. In an environment at a temperature of 25° C., at a current of 0.2 mA/cm², until a positive electrode electric potential of 4.35 V (vs. Li⁺/Li) was reached, the test cell was charged in a constant-current mode. Until a current of 0.04 mA/cm² was reached, the test cell was charged in a constant-voltage mode. After the charging, the test cell was stored for 7 days in a thermostatic chamber set at 60° C. After a lapse of 7 days, at a current of 0.2 mA/cm², until a positive electrode electric potential of 2.5 V (vs. Li⁺/Li) was reached, the test cell was discharged in a constant-current mode. After the discharging, the volume (the post-storage volume) of the test cell was measured. The pre-storage volume was subtracted from the post-storage volume to calculate the gas amount. The gas amount is found in Table 1 below. In Table 1 below, the values in column “Gas amount” are relative values. In the present example, the gas amount of No. 6 is defined as 100. The lower the gas amount is, the better the endurance is expected to be.

TABLE 1

| | Positive electrode active material | | | | | | | |
|---|---|---|---|---|---|---|---|---|
| | First particles | | | | | | Evaluation | |
| | | | Film | | | | Output | |
| | | | Amount of | | | Second particles | properties | Endurance |
| | First molar | Crystallite size | adhesion | | Value R | Second molar | Internal | Gas |
| | fraction | (Value D) | (Value C) | Metallic | (=C/D) | fraction | resistance | amount |
| No. | [−] | [Å] | [ppm] | element | [ppm/Å] | [−] | [%] | [%] |
| 1 | 0.6 | 538 | 609 | Al, B | 1.13 | 0.55 | 96 | 185 |
| 2 | 0.6 | 540 | 1088 | Al, B | 2.01 | 0.55 | 104 | 150 |
| 3 | 0.6 | 541 | 1400 | Al, B | 2.59 | 0.55 | 107 | 108 |
| 4 | 0.6 | 615 | 780 | Al, B | 1.27 | 0.55 | 103 | 130 |
| 5 | 0.6 | 602 | 930 | Al, B | 1.54 | 0.55 | 103 | 108 |
| 6 | 0.6 | 613 | 1072 | Al, B | 1.75 | 0.55 | 100 | 100 |
| 7 | 0.6 | 627 | 1064 | Al, B | 1.70 | 0.55 | 101 | 107 |
| 8 | 0.6 | 630 | 1400 | Al, B | 2.22 | 0.55 | 107 | 106 |
| 9 | 0.6 | 685 | 515 | Al, B | 0.75 | 0.55 | 98 | 134 |
| 10 | 0.6 | 681 | 620 | Al, B | 0.91 | 0.55 | 104 | 124 |
| 11 | 0.6 | 678 | 1064 | Al, B | 1.57 | 0.55 | 103 | 108 |
| 12 | 0.6 | 670 | 1385 | Al, B | 2.07 | 0.55 | 108 | 88 |
| 13 | 0.6 | 690 | 1412 | Al, B | 2.05 | 0.55 | 110 | 90 |

<Results>

In the present example, it is considered that when the internal resistance is 105% or lower and the gas amount is 110% or lower, both output properties and endurance are obtained. As found in Table 1 above, when the value R is from 1.54 to 1.75, both output properties and endurance are obtained (see No. 5, No. 6, No. 7, No. 11).

The present embodiment and the present example are illustrative in any respect. The present embodiment and the present example are non-restrictive. The scope of the present technique encompasses any modifications within the meaning and the scope equivalent to the terms of the claims. For example, it is expected that certain configurations of the present embodiments and the present examples can be optionally combined. In the case where a plurality of functions and effects are described in the present embodiment and the present example, the scope of the present technique is not limited to the scope where all these functions and effects are obtained.

What is claimed is:

1. A non-aqueous electrolyte secondary battery, comprising:
a positive electrode;
a negative electrode; and
an electrolyte solution, wherein
the positive electrode includes a positive electrode active material,
in number-based particle size distribution, the positive electrode active material includes a first peak and a second peak,
the first peak has a first vertex,
the second peak has a second vertex,
the first vertex is located on a smaller particle size side from the second vertex,
the first peak is attributed to first particles,
the second peak is attributed to second particles,
the first particles include aggregated primary particles and films,
each film is adhered to a surface of each primary particle,
the film includes a metallic element, and
relationships of the following expression (I) and expression (II) are satisfied:
R=C/D (I)
1.54≤R≤1.75 (II),
in the expression (I),
C [ppm] represents a mass fraction of the metallic element relative to the first particles, and
D [Å] represents a crystallite size of the first particles.

2. The non-aqueous electrolyte secondary battery according to claim 1, wherein the metallic element includes at least one selected from the group consisting of aluminum, boron, titanium, and yttrium.

3. The non-aqueous electrolyte secondary battery according to claim 1, wherein
the crystallite size is from 602 Å to 678 Å, and
the mass fraction is from 930 ppm to 1072 ppm.

4. The non-aqueous electrolyte secondary battery according to claim 1, wherein
in the particle size distribution,
the first vertex is located within the range of 2 μm to 6 μm, and
the second vertex is located within the range of 15 μm to 20 μm.

5. The non-aqueous electrolyte secondary battery according to claim 1, wherein
the first particles include a first lithium-nickel composite oxide,
the second particles include a second lithium-nickel composite oxide,
the first lithium-nickel composite oxide includes nickel in a first molar fraction,
the second lithium-nickel composite oxide includes nickel in a second molar fraction, and
the first molar fraction is higher than the second molar fraction.
